(19) United States
(12) Patent Application Publication
(10) Pub. No.: US 2013/0069797 A1
(43) Pub. Date: Mar. 21, 2013

(54) Vehicle Operator Distress Signaling System

(71) Applicant: Chad Howe, Lennox, SD (US)

(72) Inventor: Chad Howe, Lennox, SD (US)

(21) Appl. No.: 13/233,218

(22) Filed: Sep. 15, 2011

(51) Int. Cl. G08G 1/16

(52) U.S. Cl. 340/903

(57) ABSTRACT

A vehicle operator distress signaling system includes a pair of housings each having a control circuit and a transceiver coupled to the control circuit. A plurality of light emitters is electrically coupled to the control circuit. A plurality of actuators is electrically coupled to the control circuit and each is associated with one of the light emitters. The transceiver of one of the housings emits a distinct radio signal associated with an actuated one of the actuators and the transceiver of the one of the housings turns on the light emitter associated with the distinct radio signal. An effective transmission distance of radio signals between the housings is less than 350 m such that when the receiving transceiver loses radio signals after the effective transmission distance has been exceeded, the light emitters associated with lost ones of the radio signals turn off.

### BACKGROUND OF THE DISCLOSURE

### Field of the Disclosure

The disclosure relates to inter-vehicle distress indication system s and more particularly pertains to a new inter-vehicle distress indication system for allowing visual signals between multiple vehicle riders to prevent rearward vehicle from becoming stranded without knowledge by a forward vehicle.

### SUMMARY OF THE DISCLOSURE

An embodiment of the disclosure meets the needs presented above by generally comprising a pair of housings. Each of the housings includes a control circuit and a transceiver for transmitting and receiving radio signals is electrically coupled to the control circuit. A plurality of light emitters is electrically coupled to the control circuit. A plurality of actuators is electrically coupled to the control circuit and each is associated with one of the light emitters such that one of the light emitters is turned on when its associated one of the actuators is actuated. The transceiver of one of the housings emits a distinct radio signal associated with an actuated one of the actuators and the transceiver of the one of the housings turns on the light emitter associated with the distinct radio signal. An effective transmission distance of radio signals between the housings is less than 350 m such that the transceiver in one of the housings loses radio signals from the transceiver in another one of the housings after the effective transmission distance has been exceeded to cause the light emitters associated with lost ones of the radio signals to turn off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a vehicle operator distress signaling system according to an embodiment of the disclosure.

FIG. 2 is a bottom perspective view of an embodiment of the disclosure.

FIG. 3 is an in-use view of an embodiment of the disclosure.

FIG. 4 is a schematic view of an embodiment of the disclosure.

### DESCRIPTION OF THE PREFERRED EMBODIMENT

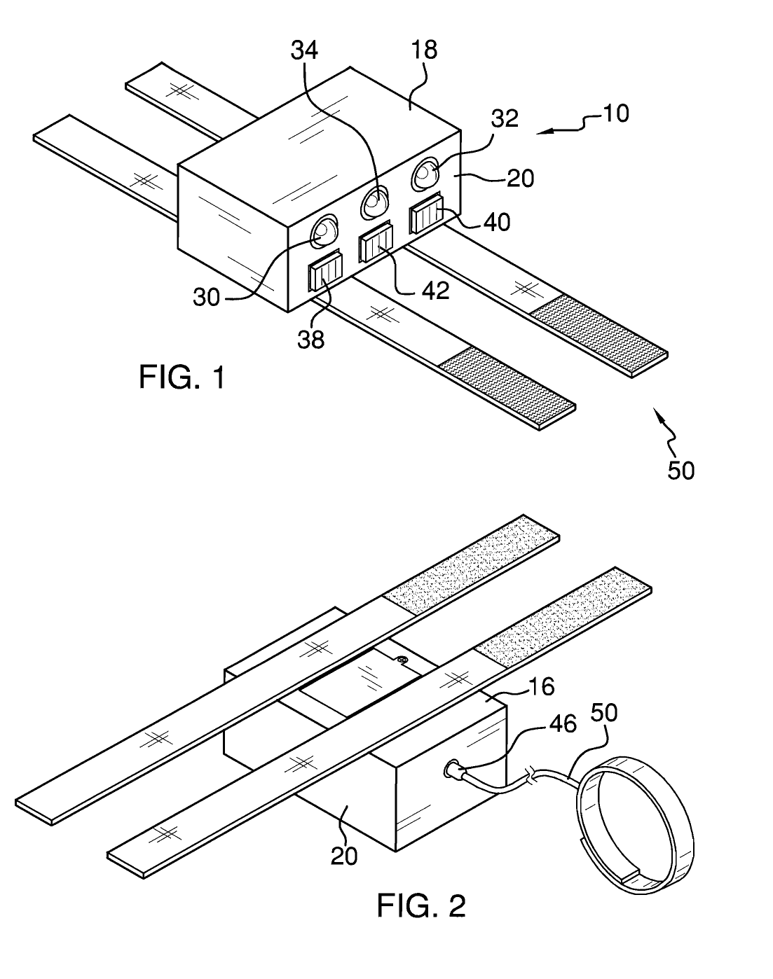

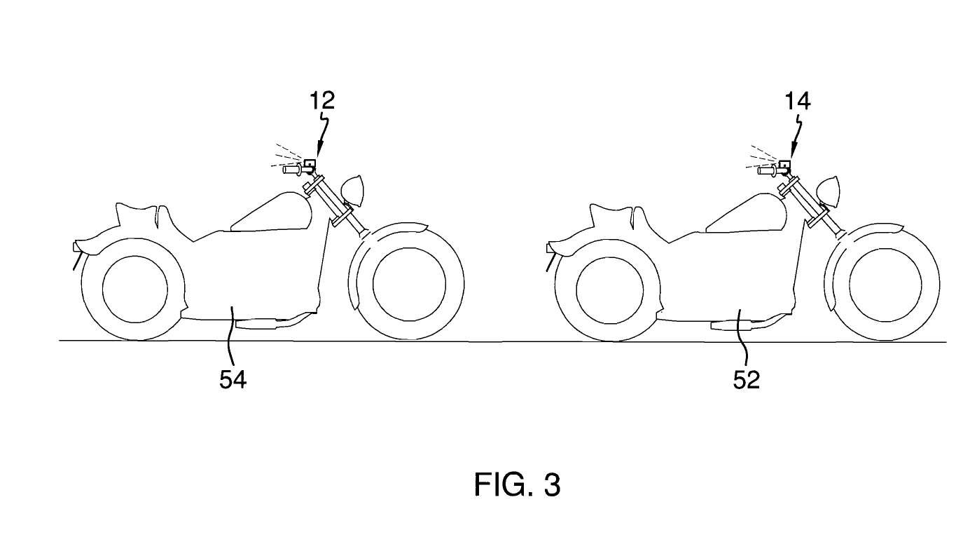

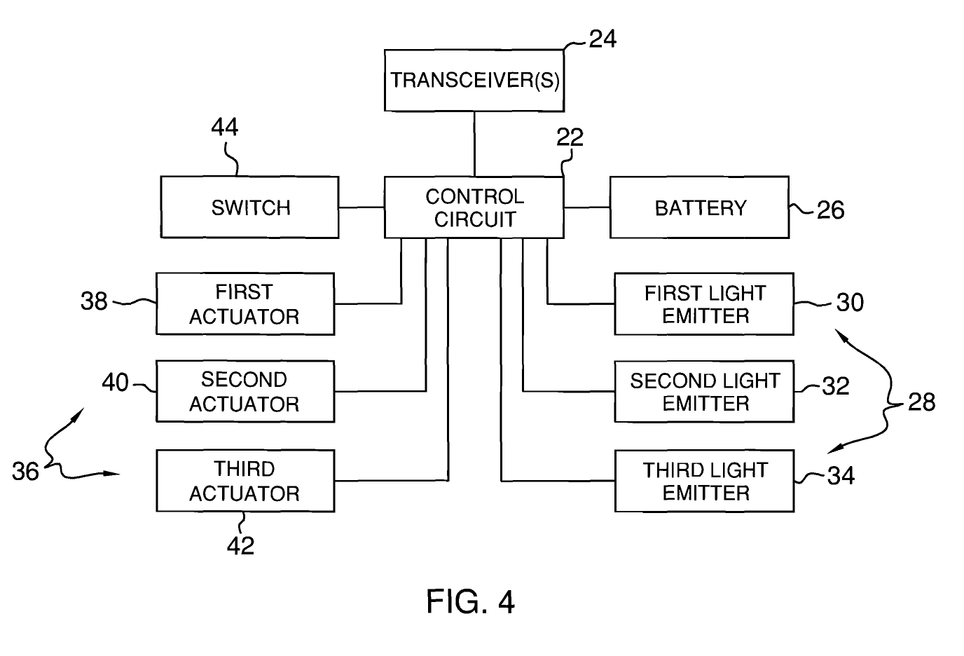

With reference now to the drawings, and in particular to FIGS. 1 through 4 thereof, a new inter-vehicle distress indication system embodying the principles and concepts of an embodiment of the disclosure and generally designated by the reference numeral 10 will be described.

As best illustrated in FIGS. 1 through 4, the vehicle operator distress signaling system 10 generally comprises a pair of housings 12, 14. The housings 12, 14 may have any suitable shape and may include, for instance, a bottom wall 16, a top wall 18 and a perimeter wall 20 being attached to and extending between the top 18 and bottom 16 walls. Each of the housings 12, 14 includes a control circuit 22 which will further include a transceiver 24 for wirelessly transmitting and receiving radio signals. The transceiver 24 is electrically coupled to the control circuit 22. It should be understood that the transceiver 24 may be comprised of a plurality of transceivers and/or a plurality of receivers and a plurality of transmitters and that essentially the system 10 is capable of sending and receiving multiple, distinct radio frequencies. A power supply 26, such as a battery, is electrically coupled to the control circuit 22.

Each housing 12, 14 further includes a plurality of light emitters 28. The light emitters 28 are each is electrically coupled to the control circuit 22. The plurality of light emitters 28 includes a first light emitter 30 and a second light emitter 32. The plurality of light emitters 28 may further include third 34, fourth, fifth and sixth light emitters though it may suffice to include at most three light emitters 28. The light emitters 28 will each have a different color with respect to each other. In particular, the first light emitter 30 may be green, the second light emitter 32 red and the third light emitter 34 yellow. The light emitters 28 may each comprise light emitting diodes though light bulbs or other light emitting assemblies may also be utilized.

Each of the housings 12, 14 also includes a plurality of actuators 36 each electrically coupled to the control circuit 22. The actuators 36 are each associated with one of the light emitters 28 such that one of the light emitters 28 is turned on when its associated one of the actuators 36 is actuated. The actuators 36 include a first actuator 38 associated with the first light emitter 30, a second actuator 40 associated with the second light emitter 32, a third actuator 42 associated with the third light emitter 34 and so on. The actuators 36 will typically be located adjacent to the associated one of the light emitters 28. Also, indicia, not shown, may be printed on the housings 12, 14 adjacent to the light emitters 28 or actuators 36 to assist a person in determining the message being conveyed by actuation of a particular one of the actuators 36. Such indicia may be positioned so that it is apparent to a user of the system as to the meaning of an illuminated one of the light emitters.

The transceiver 24 emits a first signal when the first actuator 38 is actuated, a second signal when the second actuator 40 is actuated, and a third signal when the third actuator 40 is actuated. Additional signals would be available should additional actuator 36/light emitter 28 combinations be added to the system as described above. The control circuit 22 turns on the first light emitter 30 when the first signal is received, the control circuit 22 turns on the second light emitter 32 when the second signal is received and the control circuit 22 turns on the third light emitter 34 when the third signal is received. As should be understood, additional light emitters 28 would be turned on as additional signals are received.

It should further be understood that each distinct radio signal is associated with each corresponding set of associated ones of the actuators 36 and light emitters 28. Thus, if a first actuator 38 of one housing is actuated such that the transceiver 24 of the one housing broadcasts the first signal, all other housings receiving the first signal will have their first light emitter 38 turned on while that first signal is being received. In this manner, each actuator 36 and its associated light emitter 28 is either in a transmitting or a receiving mode. Actuating the actuators 36 to an engaged position provides the transmitting mode while disengaging the actuators provides the receiving mode.

The housings 12, 14 may each include a switch 44 that is mounted on the housing 12, 14 and is electrically coupled to the control circuit 22. A plug 46 is mechanically coupled to the switch 44 and the switch 44 is actuated when the plug 46 is removed from the switch 44. The control circuit 22 prevents a transmitting of the first signal when the switch 44 is actuated and/or the transceiver 24 may transmit the second signal when the switch 44 is actuated. Thus, if a first housing 12 is transmitting the first signal, the first light emitter 30 will be illuminated on both the first housing 12 and a second housing 14 in radio communication with the first housing 12. However, if the switch 44 of the first housing 12 is actuated, the first light emitter 30 will turn off on the second housing 14 to indicate to the person viewing the second housing 14 that some sort of distress may have occurred with respect to the first housing 12. This may further be emphasized if the second signal is sent to cause the second light emitter 42 on the second housing 14 to be illuminated. The plug 46 may be attached to a tether 48 to wear around a person's arm or leg. Thus, if a person, for instance, falls from a snowmobile having the first housing 12 thereon, the second light 42 on the second housing 14 will be illuminated as long as the two housings 12, 14 are within radio range of each other.

It is preferred that that an effective, or generally specific, radio distance exists between the housings 12, 14. Thus, when two vehicles become separated by two great of a distance, the light emitters 28 which are turned on by received radio signals, will turn off to indicate to the lead vehicle that the transmitting vehicle is has fallen behind a distance which is unacceptable for retaining the vehicles in a convoy type grouping. The effective transmission distance of radio signals between the housings 12, 14 may be less than 350 m, or less than about 1150 feet, such that the transceiver 24 in one of the housings 12, 14 loses radio signals from the transceiver 24 in another one of the housings 12, 14 after the effective transmission distance has been exceeded to cause the light emitters 28 associated with lost ones of the radio signals to turn off.

A plurality of couplers 50 may also be provided. Each of the housings 12, 14 has one of the couplers 50 attached thereto. The couplers 50 attach the housings 12, 14 to objects to allow radio signaling between the objects. As shown in FIG. 1, the couplers 50 may include straps having hook and loop connectors thereon to allow the straps, for instance, to be wrapped around and secured to handlebars of a motorcycle, snowmobile, all terrain vehicle, bicycle or the like. Alternate couplers 50 may be used as required depending on type of vehicle to be used as well as placement opportunities. Thus the couplers 50 may comprise magnets, brackets, fasteners (threaded screws/bolts and the like), or other conventional coupling means. The advantage of the straps would be that it would allow easy retrofitting to vehicles having handlebars without requiring marring of drilling into the vehicle in question.

In use, the system 10 has the advantage of providing a visual indicator between two or more personal vehicles with respect to problems associated with the vehicles or persons operating them. Below are example scenarios for usage of the system 10 wherein the system 10 is used by a group of motorcycle riders. If the group includes five motorcycles, at least two housings will be used so that the front rider, or motorcycle 52, and the rear rider, or motorcycle 54, each have one of the housings 12, 14:

1) The rear rider 54 will actuate the first actuator 38 to send out the first signal to the front rider 52. This will cause the front rider's 52 first light emitter 30 (green) to turn on to indicate that the rear rider 54 is within a suitable distance of the front rider 52 and that there are no problems with intermediate riders between the front 52 and rear 54 riders.

2) Should the rear rider 54 fall back too far, the effective radio distance will cause the front rider 52 to lose signal and turn off the front rider's 52 first light emitter 30. The front rider 52 will then slow down until the signal is again received and coming to a stop if the signal is not again received so that the front rider 52 can turn around and assist whoever requires assistance.

3) Should the rear rider 54 experience immediate difficulties such as a flat tire or engine problems, or view such happening to the intermediate rider, the rear rider 54 can actuate the second actuator 40 causing the second light emitters 32 of the front 52 and rear 54 riders to be turned on. This will signal the front rider 52 to stop immediately and of course all other intermediate riders will follow the front rider's 52 lead.

4) Should the rear rider 54, an intermediate rider signaling the rear rider 54, or the front rider 52 require stoppage in the near but not immediate future, the rear rider 54 or the front rider 52 may actuate the third actuator 42 causing the third light emitters 34 of the front 52 and rear 54 riders to be turned on. The front rider 52 will then stop at the next convenient spot to do so.

5) In one embodiment more than two housings 12, 14 are employed wherein one or all of the intermediate riders may also have a housing on their motorcycles. These housings, or intermediate housings, would be used primarily to receive the first signal and only be used for transmitting the second and third signals when an immediate or near future stoppage is required.

While the above includes an example of usage between motorcycles, it may be used with any number of personal vehicles as described above.

It may also be used where communication between persons is very difficult such as while operating heavy machinery. Other uses could include signals between skiers, hikers, or other sporting activities where distances between the participants may be dangerous due to a lead person not being aware of a problems being experienced by those in the rear.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A distance signaling system to indicate a condition between two vehicles, said system including:
a pair of housings, each of said housings including;
a control circuit;
a transceiver for transmitting and receiving radio signals, said transceiver being electrically coupled to said control circuit;
a plurality of light emitters each being electrically coupled to said control circuit;
a plurality of actuators each being electrically coupled to said control circuit, each of said actuators being associated with one of said light emitters such that one of said light emitters is turned on when its associated one of said actuators is actuated;
said transceiver emitting a distinct radio signal associated with each one of an actuated one of said actuators, said control circuit turning on a light emitter associated with a radio signal received by said transmitter;
wherein an effective transmission distance of radio signals between said housings is less than 350 m such that said transceiver in one of said housings loses radio signals from said transceiver in another one of said housings after said effective transmission distance has been exceeded to cause said light emitters associated with lost ones of said radio signals to turn off.

2. The system according to claim 1, wherein said plurality of light emitters includes a first light emitter and a second light emitter, said actuators including a first actuator associated with said first light emitter and a second actuator associated with said second light emitter, said transceiver emitting a first signal when said first actuator is actuated, said transceiver emitting a second signal when said second actuator is actuated, said control circuit turning on said first light emitter when said first signal is received, said control circuit turning on said second light emitter when said second signal is received.

3. The system according to claim 2, wherein each of said housings further includes a switch being mounted on said housing and being electrically coupled to said control circuit, a plug being mechanically coupled to said switch, said switch being actuated when said plug is removed from said switch, said control circuit preventing a transmitting of said first signal when said switch is actuated.

4. The system according to claim 3, wherein said transceiver transmits said second signal when said switch is actuated.

5. The system according to claim 1, further including a plurality of couplers, each of said housings having one of said couplers attached thereto, said couplers attaching said housings to objects to allow radio signaling between the objects.

6. A distance signaling system to indicate a condition between two vehicles, said system including:
a pair of housings, each of said housings including;
a control circuit;
a transceiver for transmitting and receiving radio signals, said transceiver being electrically coupled to said control circuit;
a plurality of light emitters each being electrically coupled to said control circuit, said plurality of light emitters including a first light emitter and a second light emitter;
a plurality of actuators each being electrically coupled to said control circuit, each of said actuators being associated with one of said light emitters such that one of said light emitters is turned on when its associated one of said actuators is actuated, said actuators including a first actuator associated with said first light emitter and a second actuator associated with said second light emitter;
said transceiver emitting a first signal when said first actuator is actuated, said transceiver emitting a second signal when said second actuator is actuated, said control circuit turning on said first light emitter when said first signal is received, said control circuit turning on said second light emitter when said second signal is received;
a switch being mounted on said housing and being electrically coupled to said control circuit, a plug being mechanically coupled to said switch, said switch being actuated when said plug is removed from said switch, said control circuit preventing a transmitting of said first signal when said switch is actuated, said transceiver transmitting said second signal when said switch is actuated;
wherein an effective transmission distance of radio signals between said housings is less than 350 m such that said transceiver in one of said housings loses radio signals from said transceiver in another one of said housings after said effective transmission distance has been exceeded to cause said light emitters associated with lost ones of said radio signals to turn off; and
a plurality of couplers, each of said housings having one of said couplers attached thereto, said couplers attaching said housings to objects to allow radio signaling between the objects.
